(19) United States
(12) Patent Application Publication
(10) Pub. No.: US 2005/0094037 A1
(43) Pub. Date: May 5, 2005

(54) Color uniformity shading element for cathode ray tube-based image display device

(76) Inventors: Toshiyuki Kawashima, North Huntingdon, PA (US); Masanori Takenaka, Tokyo (JP); Christopher Palassis, Pittsburgh, PA (US); Keiichi Yoneyama, Kanagawa-ken (JP)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/699,046

(22) Filed: Oct. 31, 2003

(51) Int. Cl. H04N 5/74

(52) U.S. Cl. 348/779; 348/745

(57) ABSTRACT

A projecting image display device such as a rear projection type television receiver is provided that includes at least three image projecting sources for projecting images in a different color of light and a viewing screen on which the images are projected. The device also includes at least three lens assemblies each disposed in an optical path between one of the image projecting sources and the viewing screen. Each of the lens assemblies includes a plurality of lens elements. A shading element, which is affixed to at least one of the lens elements, has a shape and orientation on the lens element that causes an increase in color uniformity across the viewing screen.

### FIELD OF THE INVENTION

This invention relates generally projection type image display devices, and more particularly to a projection type image display device such as a cathode ray tube projection television in which color uniformity is enhanced.

### BACKGROUND OF THE INVENTION

Rear projection type television receivers are very popular due to the large display screens that are available without the need for special installations and/or large viewing areas. In such receivers, three color cathode ray tubes (red, green and blue) project an image onto a mirror, with the image being reflected (and magnified) onto a display screen that may comprise a Fresnel lens arrangement combined with a diffuser. In a rear-projection type television receiver, the viewer sees the picture on the opposite side of the screen from the side where the images are projected.

FIG. 1 is a schematic illustration of a conventional optical system for a projecting image display device such as the aforementioned rear projection type television receiver. As shown, the cathode-ray tubes of the three primary colors are arranged in the direction from the left to the right with respect to the screen 8. Usually the green cathode-ray tube 10G is located at the center and the red cathode-ray tube 10R and the blue cathode ray tube 10B are located on the left and the right sides thereof, respectively, so that the optical axes of the different tubes intersect with each other at a point on the screen. The angle Θ defines the angles formed by the optical axes of the red and blue cathode ray tubes with respect to the centrally disposed optical axis of the green cathode ray tube. Because the cathode ray tubes project from different directions, their distribution of brightness on the screen 8 differ from one another, thus making color uniformity difficult to achieve. For example, when a white image is projected over the entire screen, fluctuations in the color are produced, i.e. the image is locally reddish or bluish.

Also shown in FIG. 1 are lens assemblies 20R, 20G, and 20B, which are located in front of cathode ray tubes 10R, 10G, and 10B, respectively. The lens assemblies focus the images produced by the cathode ray tubes to form a picture on the screen 8.

FIG. 2 is a front view of the screen 8 (i.e., the side of the screen observed by the viewer), on which a coordinate system is defined so that the origin is positioned at the screen center 8C; the positive direction of the x-axis is directed towards the right in the horizontal direction; and the positive direction of the y-axis is directed upward in the vertical direction. Further, in FIGS. 1 and 2, H and W represent the width and the height of the screen.

FIG. 3 shows the distribution of the illuminance in the plane of the screen position 8 taken along a horizontal line passing through the center of the screen 8, in which the abscissa represents the horizontal position along the plane and the ordinate the relative illuminance. At the center 8C of the screen position all the illuminances for red, green and blue have been normalized to 1 (representing white light). The broken line indicates the distribution of the illuminance for red, the dotted line that for green, and the full line that for blue. While the distribution of the illuminance for green is seen to be symmetric with respect to the center of the screen, the distribution of the illuminance for red deviates towards the left on the screen and that for blue deviates towards the right at the screen position. It can be shown that the magnitude of this deviation increases with an increase in the cathode ray tube optical axis offset angle Θ.

As the result of the illuminance distribution in FIG. 3, since on the left side of the screen the relative illuminance for red is higher and that for blue is lower than that for green, the color temperature is low and this portion of the screen appears reddish or yellowish. Likewise, since on the right side of the screen the relative illuminance for red is lower and that for blue is higher than that for green, the color temperature is high and this portion of the screen appear bluish or cyanish. Accordingly, an observer will see fluctuations in color across the screen 8 that arise from the geometric arrangement of the three cathode ray tubes. Moreover, these color fluctuations are exaserbated when projection display devices are reduced in size by decreasing the distance between the lens assemblies 20 and the screen 8. Such a reduction in size produces an increase in the cathode ray tube optical axis offset angle Θ, which as previously mentioned, causes a corresponding increase in the magnitude of the color deviation.

U.S. Pat. No. 5,103,302, which is hereby incorporated by reference in its entirety, reduces the aforementioned color fluctuations by providing plates that are located along the optical axis of each lens assembly 20. The plates have apertures that are traversed by the light from the cathode ray tube associated with that plate. The apertures are axially asymmetric with respect to their optical axes so that the distribution of light from each cathode ray tube along the screen is made more uniform. That is, referring to FIG. 3, the plate aperture in the optical path of the red cathode ray tube is generally configured to block more light directed to the left side of the screen while the plate aperture in the optical path of the blue cathode ray tube is generally configured to block more light directed to the right side of the screen. By using plates with appropriately shaped apertures the color fluctuations appearing on the screen can be substantially reduced.

A number of limitations arise in connection with the use of the plates to enhance color uniformity. For example, it can be difficult to control the tolerances of the plate during its manufacture and placement, which can lead to image defects. Also, the plate increases the number of optical components that are required, thereby increasing the cost and complexity of assembly.

Accordingly, it would be desirable to provide an optical system for a projecting image display device that employs multiple image sources such as cathode ray tubes in which color uniformity can be achieved in a simpler and less expensive manner.

### SUMMARY OF THE INVENTION

In accordance with the present invention, a projecting image display device is provided that includes at least three image projecting sources for projecting images in a different color of light and a viewing screen on which the images are projected. The device also includes at least three lens assemblies each disposed in an optical path between one of the image projecting sources and the viewing screen. Each of the lens assemblies includes a plurality of lens elements. A shading element, which is affixed to at least one of the lens elements, has a shape and orientation on the lens element that causes an increase in color uniformity across the viewing screen.

In accordance with one aspect of the invention, the shading element is opaque.

In accordance with another aspect of the invention, the shading element is grayscale translucent.

In accordance with another aspect of the invention, the shading element is color translucent.

In accordance with another aspect of the invention, the shading element is painted onto the lens element.

In accordance with another aspect of the invention, the shading element is printed onto the lens element.

In accordance with another aspect of the invention, an adhesive affixes the shading element to the lens element.

In accordance with another aspect of the invention, at least three shading elements are each affixed to a lens element in a different one of the lens assemblies.

In accordance with another aspect of the invention, the image projecting sources are cathode ray tubes

In accordance with another aspect of the invention, the cathode ray tubes project images in red, green and blue light, respectively.

In accordance with another aspect of the invention, each of the lens assemblies comprise a plurality of lens elements.

In accordance with another aspect of the invention, the plurality of lens elements includes an aberration correcting element, a power element and a field flattener element.

In accordance with another aspect of the invention, the shading element is affixed to the aberration correcting element.

In accordance with another aspect of the invention, the lens element includes an alignment member for rotationally aligning the lens element.

In accordance with another aspect of the invention, the alignment member comprises at least one boss.

In accordance with another aspect of the invention, the alignment member is at least one registration mark located on a surface of the lens element.

### BRIEF DESCRIPTION OF THE DRAWINGS

FIG. 1 is a schematic illustration of a conventional optical system for a projecting image display device such as a rear projection type television receiver.

FIG. 2 is a front view of the screen seen in FIG. 1.

FIG. 3 shows the distribution of the illuminance in the plane of the screen position seen in FIG. 2.

FIG. 4 is a schematic diagram of an exemplary projecting image display device in which the present invention may be employed.

FIG. 5 is a cross-sectional view of one embodiment of an optical system that includes the cathode ray tube and lens assembly illustrated in FIG. 4.

FIGS. 6(a)-6(e) show a lens element on which one or more exemplary shading elements are applied in accordance with the present invention.

FIGS. 7(a)-7(c) show alternative mechanisms for properly aligning the lens element about its optical axis.

### DETAILED DESCRIPTION

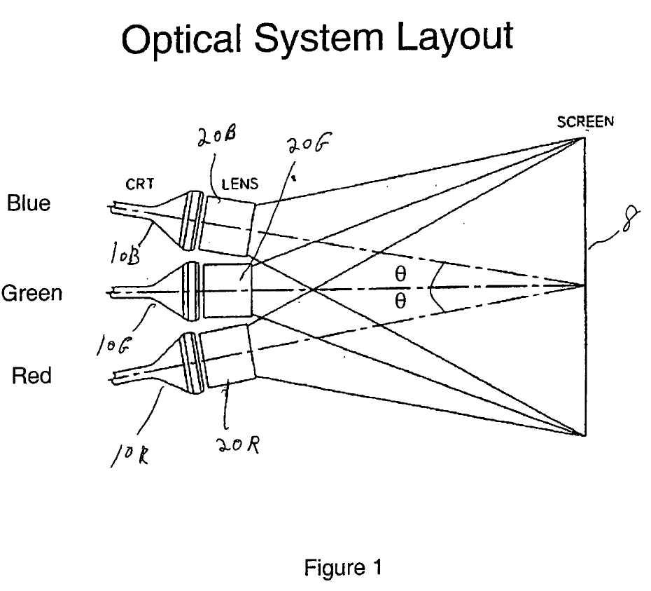

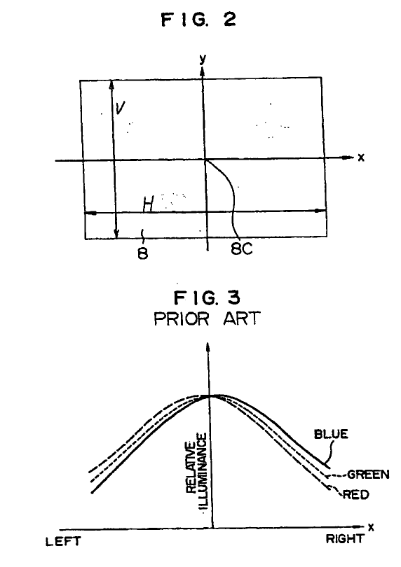

FIG. 4 is a schematic diagram of an exemplary projecting image display device in which the present invention may be employed. While the display device is illustrated as a rear projection television receiver, those of ordinary skill in the art will recognize that the invention is equally applicable to other projecting image display devices. A cathode ray tube 40 projects an image though a lens assembly 42 located in front of the tube 40. While for purposes of clarity FIG. 4 only shows a single cathode ray tube, one of ordinary skill in the art will recognize that three cathode ray tubes such as shown in FIG. 1 are typically employed. Associated with the cathode ray tube 40 is a chassis (not shown) that supplies operating voltages and video information to the cathode ray tube 40 by well known means. The lens assembly 42, which will be discussed in more detail below, has a focal length that is selected so that an image produced by the tube 40 is reflected by mirror 41 and appears as an image on a viewing screen 43.

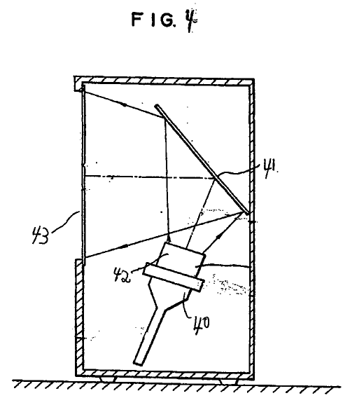

FIG. 5 is a cross-sectional view of one embodiment of an optical system 50 that comprises cathode ray tube 40 and lens assembly 42 illustrated in FIG. 4. Optical system 50 includes cathode ray tube 51 having a screen 51a. A coupler 52 is attached to the faceplate of the cathode ray tube 51. The coupler 52 is filled with a liquid cooling medium for cooling the cathode ray tube 51. The lens assembly 57 is arranged to receive the light from the cathode ray tube 51 via coupler 52 and projects the image onto the screen 43 seen in FIG. 4.

The lens assembly 57 comprises three lens units 53, 54 and 55. Each lens unit performs a specified optical function or functions and may employ one or more lens elements. That is, the term “lens unit” refers to one or more lens elements or lens components which provide a defined optical function or functions in the design of the overall lens. The first lens unit 54, which is remote from cathode ray tube 51, includes a biconvex element which supplies all or substantially all of the positive power of the lens. The second lens unit 53 has at least one aspheric surface, which serves as an aberration corrector. The third lens unit 55 nearest the cathode ray tube 51 has a concave surface facing the second lens unit 54 and serves as a field flattener, essentially correcting Petzval curvature of the first and/or second lens units.

In accordance with the present invention, the plate employed in U.S. Pat. No. 5,103,302 is replaced with one or more shading elements that are applied directly to one or more of the lens elements in lens assembly 57. The shading elements may be applied to the lens element by any appropriate means. For example, the shading elements may be painted, printed or affixed with adhesive to the lens element. While the shading elements may be applied to any of the individual lens elements employed in the lens assembly 57, it will generally be preferable to apply them to one of the lens elements in the third lens unit 55 since in this way shading will be accomplished prior to image magnification by the second lens unit 54.

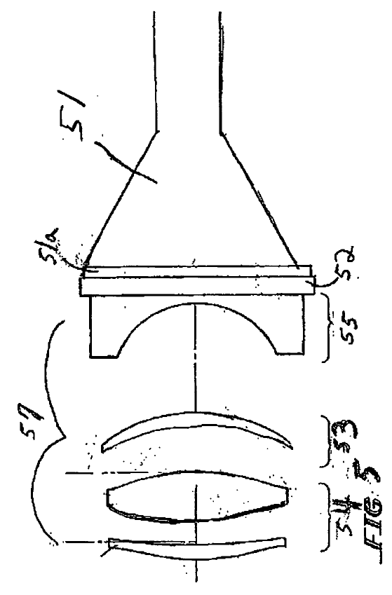

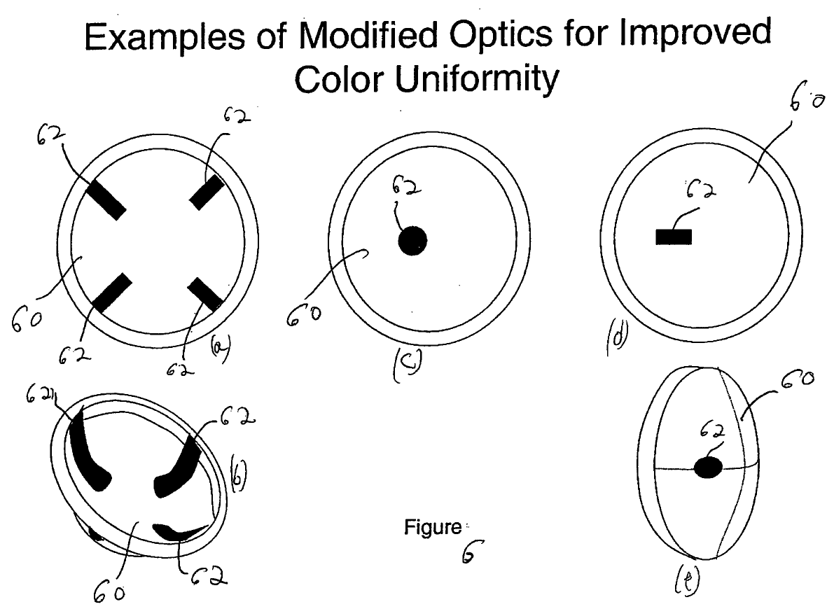

FIGS. 6(a)-6(e) show a lens element 60 on which one or more exemplary shading elements 62 are applied. A number of advantages arise from the use of shading elements 62 instead of the plates discussed in the aforementioned patent. First, the tolerances of the shading element can be better controlled than the tolerances of the plate, thereby reducing defects. Second, because the shading element 62 is integral with the lens element 60, the number of optical components that are required is reduced, thereby reducing cost and facilitating ease of assembly. Third, the number and variety of differently shaped shading elements 62 that can be readily employed is greater than can be achieved with the use of a plate. This allows for customized shading patterns to be used, which can better achieve more optimal color uniformity because different shading elements can be employed that only affect color uniformity on one portion of the screen (e.g., the center) without affecting color uniformity on another portion of the screen (i.e. the corners).

Another important advantage of the present invention is that the shading elements need not necessarily be opaque. Rather, the shading elements may have varying degrees of grayscale or color translucency. This provides another means by which the color intensity across the screen can be varied. Moreover, because only the spectral portion of light necessary to achieve color uniformity is blocked, this approach is less detrimental to the overall image brightness in comparison to a shading element that is opaque.

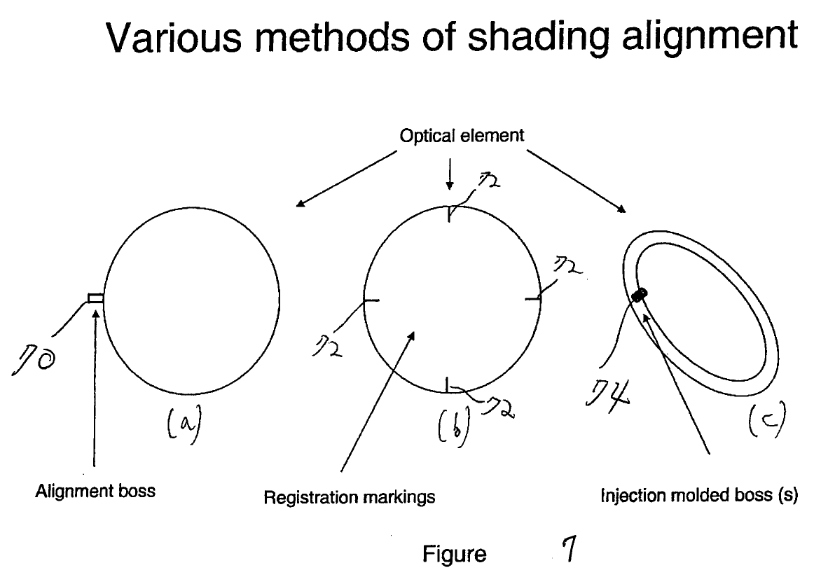

Because the shading elements are applied directly to the lens element, it will generally be necessary to properly align the lens element about its optical axis. Such alignment can be achieved in a variety of different ways. For example, as shown in FIG. 7(a) a boss or bosses 70 can be molded onto the lens flange that engages with a lens assembly holder. Alternatively, as indicated in FIG. 7(b), registration marks 72 may be added to the lens element, which may be molded directly into the lens during or after lens formation. In yet another alternative shown in FIG. 7(c), a boss or bosses 74 can be injection molded onto the lens element.

1. A projecting image display device, comprising:
at least three image projecting sources for projecting images in a different color of light;
a viewing screen on which the images are projected;
at least three lens assemblies each disposed in an optical path between one of the image projecting sources and the viewing screen, each of said lens assemblies including a plurality of lens elements; and
a shading element affixed to at least one of the lens elements, wherein said shading element has a shape and orientation on the lens element that causes an increase in color uniformity across the viewing screen.

2. The projecting image display device of claim 1 wherein said shading element is opaque.

3. The projecting image display device of claim 1 wherein said shading element is grayscale translucent.

4. The projecting image display device of claim 1 wherein said shading element is color translucent.

5. The projecting image display device of claim 1 wherein said shading element is painted onto the lens element.

6. The projecting image display device of claim 1 wherein said shading element is printed onto the lens element.

7. The projecting image display device of claim 1 further comprising an adhesive affixing said shading element to the lens element.

8. The projecting image display device of claim 1 further comprising at least three shading elements each affixed to a lens element in a different one of the lens assemblies.

9. The projecting image display device of claim 1 wherein said image projecting sources are cathode ray tubes

10. The projecting image display device of claim 9 wherein said cathode ray tubes project images in red, green and blue light, respectively.

11. The projecting image display device of claim 1 wherein each of the lens assemblies comprise a plurality of lens elements.

12. The projecting image display device of claim 11 wherein said plurality of leans elements includes an aberration correcting element, a power element and a field flattener element.

13. The projecting image display device of claim 12 wherein said shading element is affixed to the aberration correcting element.

14. The projecting image display device of claim 1 wherein said lens element includes an alignment member for rotationally aligning the lens element.

15. The projecting image display device of claim 14 wherein said alignment member comprises at least one boss.

16. The projecting image display device of claim 14 wherein said alignment member is at least one registration mark located on a surface of the lens element.

17. A method of displaying an image on a viewing screen of an image display device, said method comprising the steps of:
generating an image in at least three colors of light; and
projecting the image in each of the three colors of light onto the viewing screen with a lens assembly having affixed thereto a shading element that causes an increase in color uniformity across the viewing screen.

18. The method of claim 17 wherein said shading element comprises a translucent element.

19. A method of forming a lens assembly for use in an image display device, comprising:
providing at least one lens element that receives an image in a single color of light from a cathode ray tube and projects said image onto a viewing screen of the image display device; and
affixing to said at least one lens element a shading element that causes an increase in uniformity of the single color across the viewing screen.

20. The method of claim 19 wherein the affixing step comprises the step of painting the shading element onto the lens element.
